(19) United States
(12) Patent Application Publication
(10) Pub. No.: US 2026/0326044 A1
(43) Pub. Date: Oct. 22, 2026

(54) A METAL-ORGANIC FRAMEWORK MEMBRANE

(71) Applicant: NATIONAL UNIVERSITY OF SINGAPORE, Singapore (SG)

(72) Inventors: John WANG, Singapore (SG); Jianguo SUN, Singapore (SG); Chin Ho KIRK, Singapore (SG); Tuo WANG, Singapore (SG)

(21) Appl. No.: 19/113,227

(22) PCT Filed: Sep. 19, 2023
(86) PCT No.: PCT/SG2023/050634

§ 371 Date: Mar. 19, 2025

(30) Foreign Application Priority Data
Sep. 19, 2022 (SG) 10202251064P

(51) Int. Cl. B01D 71/02; B01D 53/22; B01D 67/00; B01D 69/02; B01D 69/10

(52) U.S. Cl. CPC B01D 71/028; B01D 53/228; B01D 67/0079; B01D 69/02; B01D 69/108; B01D 2325/0212; B01D 2325/04

(57) ABSTRACT

A metal-organic framework membrane There is provided an amorphous monolithic metal-organic framework membrane which is free of grain boundaries and grain junctions. There is also provided a method of forming the same.

### TECHNICAL FIELD

The present invention relates to an improved metal-organic framework (MOF) membrane.

### BACKGROUND

Metal Organic Frameworks (MOFs) are a class of metal-organic crystalline materials with well-defined structures and micropores down to angstrom range. They are characterized by a high and controllable level of porosity, high surface areas, and tunable micropore sizes. MOFs have been used in many applications such as in gas separation, gas storage, CO₂ capture, and catalysis, just to name a few.

However, growth of MOF crystals on a substrate using solution-based methods creates unavoidable macro- and micro-defects at the grain boundaries and junctions of the polycrystalline structures, leading to poor selectivity in gas separation applications. While other methods which mitigate the macro-defects and micro-defects have been used, for example by growing the MOFs to a few micrometers thick, the macro-/micro-pores arising from the polycrystal stacking still cannot be eliminated.

Amorphous MOFs have been formed where crystalline MOFs are subjected to a very high pressure with/without temperature control. This causes the framework coordination to soften, forming a disordered amorphous structure that still retains some permanent micro-pores. However, the amorphous MOFs formed to date are processed at very high pressure and under very stringent conditions, making them unsuitable for production at industrial scale. Thus, there is a need for an improved MOF membrane and method of forming the same.

### SUMMARY OF THE INVENTION

The present invention seeks to address these problems, and/or to provide an improved metal-organic framework (MOF) membrane, particularly an amorphous monolithic MOF membrane, as well as a method of forming the same.

According to a first aspect, the present invention provides an amorphous monolithic metal-organic framework membrane, wherein the membrane is free of grain boundaries and grain junctions.

According to a particular aspect, the membrane may be a continuous membrane.

The membrane may comprise uniform pores. Each of the pores may have a suitable size. For example, the pores may each have an average pore size of 0.4-0.7 nm.

The membrane may have a suitable thickness. for example, the membrane may have a thickness of ≤10 μm.

The membrane may have a suitable gas flux. For example, the membrane may have a gas flux of 10⁻⁴-10⁻⁶ m⁻²s⁻¹Pa⁻¹.

The membrane may be formed on a substrate. The substrate may be any suitable substrate. For example, the substrate may comprise, but is not limited to, a metal foam. According to a particular aspect, the membrane may be provided between two substrates. Each of the two substrates may be the same or different substrate. For example, the membrane may be sandwiched between two substrates.

The MOF comprised in the membrane may be any suitable MOF. According to a particular aspect, the membrane may comprise, but is not limited to, a copper-based MOF.

The MOF comprised in the membrane may comprise a suitable linker. The linker may be an organic linker. For example, the organic linker may comprise, but is not limited to: benzenetricarboxylate ligand, benzenedicarboxylate ligand, or a combination thereof. The linker may have a suitable molecular weight. For example, the linker may have a molecular weight of 150-250 g/mol.

According to a second aspect, there is provided a method of forming an amorphous monolithic metal-organic framework (MOF) membrane, the method comprising:
providing metal-organic framework powder on a substrate; and
applying a pressure of ≤1 GPa to form the amorphous monolithic MOF membrane.

The substrate may be as described above in relation to the first aspect.

The MOF may be as described above. The MOF may comprise a linker. The linker may be as described above. In particular, the linker may be an organic linker. Even more in particular, the linker may have a molecular weight of 150-250 g/mol. For example, the organic linker may be, but is not limited to: benzenetricarboxylate ligand, benzenedicarboxylate ligand, or a combination thereof.

The applying may comprise applying a suitable pressure of ≤1 GPa. In particular, the applying may comprise applying a pressure of 450 MPa to 1 GPa.

The applying may be carried out under suitable conditions. For example, the applying may be carried out at room temperature.

According to a particular aspect, the method may further comprise providing a further substrate thereby sandwiching the amorphous monolithic MOF membrane between the two substrates. The further substrate may be as described above.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows surface scanning electron microscopy (SEM) of one embodiment of a membrane of the present invention under different applied pressures;

FIG. 2(a) and FIG. 2(b) show schematic representations of a membrane formed on a substrate according to particular embodiments;

FIG. 3 shows the X-ray diffraction patterns of one embodiment of a membrane under various pressures^{o};

FIG. 4(a) shows the surface SEM image of the membrane according to one embodiment pressed under 473 MPa and FIG. 4(b) shows the surface SEM image of the membrane according to one embodiment pressed under 874 MPa;

FIG. 5 shows the differential scanning calorimetry (DSC) characterization of crystalline and amorphous membrane according to one embodiment showing glass transition temperature T_{g};

FIG. 6 shows the micropore size distribution obtained using Brunauer-Emmett-Teller (BET) for crystalline membrane according to one embodiment and an amorphous monolith membrane pressed at 874 MPa;

FIG. 7(a) shows N₂ dry flow for macropores testing for Ni foam substrate under 874 MPa and FIG. 7(b) shows the N₂ dry flow for macropores testing for a membrane according to one embodiment on a Ni foam substrate under 874 MPa; and

FIG. 8 shows gas separation of CO₂ and C₃H₈ under 1 atm pressure using the membrane according to one embodiment.

### DETAILED DESCRIPTION

As explained above, there is a need for an improved MOF membrane and method of forming the same.

In general terms, the present invention provides an improved MOF membrane, particularly an amorphous monolithic MOF membrane, as well as a method of forming the same. The improved MOF membrane may be an amorphous monolithic MOF membrane with tunable pore sizes making the MOF suitable for many different applications such as, but not limited to, fluid separation applications. With the MOF membrane, fluid separation may be performed by a simple filtration process which has low energy requirements. The invention also relates to a method of forming the MOF membrane which is a simple, low-cost and scalable method. In particular, the method involves a simple low-pressure press method which enables the MOF membrane to be formed in a short amount of time.

According to a first aspect, there is provided an amorphous monolithic metal-organic framework (MOF) membrane, wherein the membrane is free of grain boundaries and grain junctions.

For the purposes of the present invention, an amorphous monolithic membrane refers to a membrane which is substantially similar in structure to a glass MOF membrane. The amorphous monolithic membrane may differ from the crystalline periodic structure in that it comprises characteristic broadening of XRD peaks. There may also be an emergence of glass transition temperature for the amorphous structure when using differential thermal analysis.

In particular, the membrane may be a continuous membrane since there are no voids grain boundaries and grain junctions.

The membrane has no macro-porous defects, particularly in the 2D dimension, as unwanted macro-pores at the MOF grain boundaries and grain junctions are eliminated. In this way, there is precise control of the size of the pores comprised in the membrane. The high inter-connected pore structure of the membrane enables an overall high pore volume and provides inter-connected pore channels without boundary anisotropy, which in turn results in a high gas flux when the membrane is in use for fluid separation applications. In particular, before a membrane can be used for applications such as gas separation, it is important for macropores to be eliminated. In the presence of macropores, the gas molecules may preferentially transport through the large pores, and the selectivity may be limited to natural diffusion.

The membrane may comprise substantially uniform-sized pores. Alternatively, the pores may have a narrow pore size distribution. For example, the average pore size of each pore may be 0.2-1.5 nm. In particular, the average pore size may be 0.4-1.0 nm, 0.5-0.8 nm, 0.6-0.7 nm. Even more in particular, the pore size may be 0.4-0.7 nm, preferably 0.5-0.7 nm. According to a particular aspect, the pore size of the pores comprised in the membrane may be tailored depending on the application for which the membrane is to be used. For example, the pore size and pore channels may be fine-tuned to suit the selectivity of specific fluids when the membrane is used in fluid separation applications.

The membrane may have a suitable thickness. For example, the thickness of the membrane may be ≤10 μm. In particular, the thickness may be 0.5-9 μm, 0.8-8 μm, 0.7-6 μm, 1-5 μm, 2-4 μm, 2.5-3 μm. Even more in particular, the thickness may be 1-5 μm.

The membrane may have a suitable gas flux. The gas flux of the membrane may change depending on the thickness of the membrane. According to a particular aspect, the membrane may have a gas flux of 10⁻⁴-10⁻⁶ m⁻²s⁻¹Pa⁻¹.

The membrane may be formed on a substrate. The substrate may be any suitable substrate. For example, the substrate may comprise, but is not limited to, a metal, porous ceramics, and the like. The metal may be any suitable metal. For example, the metal may comprise, but is not limited to, nickel, copper, aluminium, alloys or combinations thereof. According to a particular aspect, the substrate may comprise a metal foam, such as, but not limited to, a nickel foam.

According to a particular aspect, the membrane may be provided between two substrates. Each of the two substrates may be the same or different substrate. Each of the two substrates may be as described above. For example, the membrane may be sandwiched between two substrates.

The MOF comprised in the membrane may be any suitable MOF. For example, the MOF may comprise, but is not limited to, copper-based, zinc-based, iron-based, titanium-based, alloys or mixtures thereof, metal-organic framework.

The metal-organic framework comprised in the membrane may comprise a suitable linker. The linker may be an organic linker. According to a particular aspect, the organic linker may comprise: a benzenetricarboxylate ligand, benzenedicarboxylate ligand, or a combination thereof. In particular, the organic linker may be, but not limited to, 1,3,5-benzenetricarboxylic acid, 1,4-benzenedicarboxylic acid, or a combination thereof.

The linker may comprise a suitable molecular weight. In particular, the molecular weight of the organic linker may be 150-250 g/mol. For example, the molecular weight of the linker may be 160-220 g/mol, 170-210 g/mol, 180-200 g/mol, 190-195 g/mol.

The membrane according to the present invention may be used in many applications, such as, but not limited to, gas-gas separation, solvent-solvent separation and solvent-water separation.

According to a second aspect, there is provided a method of forming an amorphous monolithic metal-organic framework (MOF) membrane, the method comprising:
providing metal-organic framework powder on a substrate; and
applying a pressure of ≤1 GPa to form the amorphous monolithic MOF membrane.

The substrate may be as described above in relation to the first aspect.

According to a particular aspect, the MOF may be any suitable MOF. For example, the MOF may be as described above.

The MOF may comprise a linker. The linker may be any suitable linker. For example, the linker may be as described above in relation to the first aspect. In particular, the linker may be an organic linker. Even more in particular, the linker may have a molecular weight of 150-250 g/mol. For example, the molecular weight of the linker may be 160-220 g/mol, 170-210 g/mol, 180-200 g/mol, 190-195 g/mol.

According to a particular aspect, the linker may be, but not limited to, benzenetricarboxylate ligands, benzenedicarboxylate ligand, or a combination thereof. In particular, the linker may be, but not limited to, 1,3,5-benzenetricarboxylic acid, 1,4-benzenedicarboxylic acid, or a combination thereof.

The applying may comprise applying a suitable pressure ≤1 GPa (i.e. 1000 MPa). For example, the pressure may be 250-1000 MPa, 300-900 MPa, 350-850 MPa, 400-800 MPa, 450-750 MPa, 500-700 MPa, 600-650 MPa. In particular, the pressure may be 450-1000 MPa. Even more in particular, the pressure may be 600-850 MPa.

The applying may be carried out under suitable conditions. For example, the applying may be carried out at room temperature.

The softening and relaxation of the coordination frameworks under low pressure helps remove the grain boundaries and junctions, which thus eliminate the structure anisotropy and the unwanted pores at the grain boundaries and junctions, giving rise to boundary-less MOF structures with uniformly-sized pores in the angstrom ranges, which are ideal for gas separation with high flux. The applied low pressure in processing also forms a dense structure with no grain boundaries and thus no macro-pores such that the selectivity is ensured for targeted gas separations. The degree of MOF amorphization and pore sizes within the amorphous MOF membranes may well be controlled by the pressure used.

According to a particular embodiment, when the applied pressure increased from 174.8 MPa to 874 MPa, the macropores of HKUST-1 MOF gradually reduced to zero, as can be seen in FIG. 1. In this way, the elimination of unwanted macropores at the MOF grain boundaries/junctions allows effective reduction of pore size towards the micropore range. The amorphous monolith MOF structure also provides inter-connected pore channels without boundary anisotropy, thereby providing the possibility of gas separation through the micropores.

Additionally, the micro-pores in the amorphous MOF can also be controlled by varying the metal types during the initial MOF synthesis. By this new method, a thin membrane of amorphous MOF glass may be fabricated with precisely tunable pore sizes for different gas separation applications.

According to a particular aspect, the method may further comprise providing a further substrate thereby sandwiching the amorphous monolithic MOF membrane between the two substrates. The further substrate may be as described above.

By providing a substrate, the thin membranes may be formed with large dimensions without the risk of cracking, thereby being suitable for large scale applications.

The method is a simple method. Accordingly, the method may be a low-cost method and the membrane may be formed within a short period of time such as 20-150 seconds, 30-100 seconds, 40-90 seconds, 45-60 seconds. In particular, the membrane may be formed within 30 seconds. In this way, long fabrication time of 12-78 hours may be avoided as required by prior art methods.

Having now generally described the invention, the same will be more readily understood through reference to the following example which is provided by way of illustration, and is not intended to be limiting.

### Example

### Materials

All chemicals are from Sigma-Aldrich.

### Preparation of Amorphous Monolithic HKUST-1 Metal Organic Framework (MOF) Membrane

Crystalline HKUST-1 MOF powders were synthesized. Cu, benzene-1,3,5-tricarboxylate (BTC), DI water, and ethanol were mixed together in a beaker using a magnetic stirrer at 200 RPM for 2 hours. The mixture was then centrifuged and decanted to remove the excess liquid. After decanting, the remaining powder was dried at 60 °C for 24 hours to form HKUST-1.

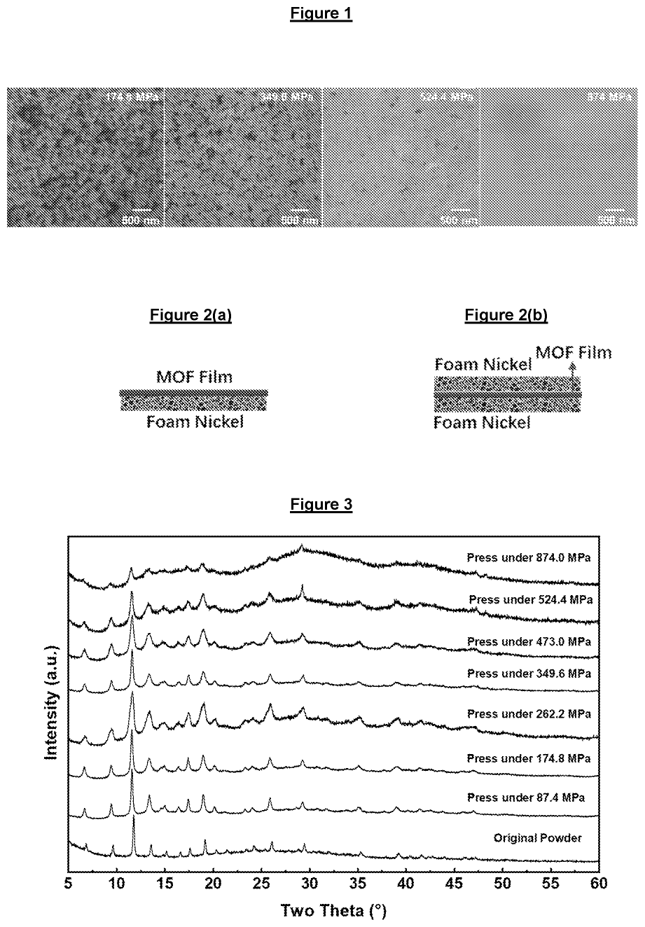

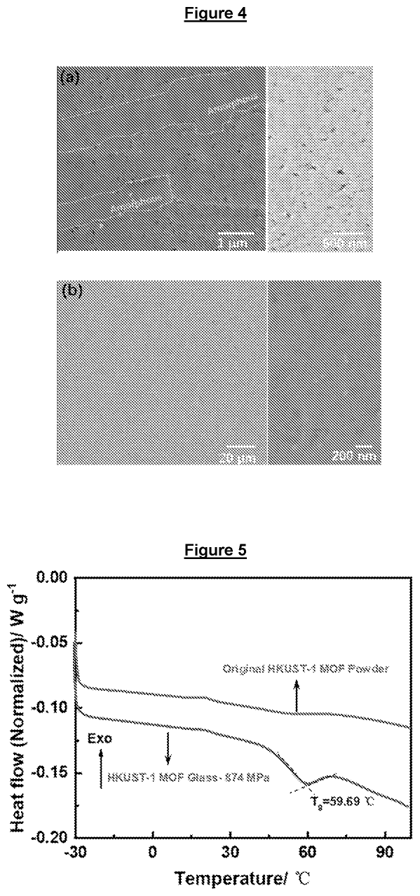

HKUST-1 powders (10-20 mg) were then pressed in a 10 mm die, at a pressure in the range 87.4 to 874 MPa. Porous Ni foam metal was used as the supporting substrate, as shown in FIG. 2(a).

After pressing, the HKUST-1 powders amorphized to form a thin glass membrane on the metal foam substrate. This provided a degree of ductility to the membrane and prevented the otherwise brittle HKUST-1 MOF glass from cracking. For additional stability, the Ni foam was applied on both sides of the HKUST-1 MOF glass, as shown in FIG. 2(b). The thin membrane can be immediately used the as pressed without further processing.

As shown in FIG. 3 [symbol] diffraction peaks in HKUST-1 tended to broaden when the applied pressure was increased. This corresponds to an increased degree of amorphization of the HKUST-1 films. It was also observed that at high pressure of 874 MPa, the HKUST-1 MOF glass appeared translucent, which is characteristic of high density and low thickness.

Surface scanning electron microscope (SEM) images of FIG. 4 show the gradual amorphization of the crystalline HKUST-1 MOF. At 473 MPa, some amorphous regions started to form, as highlighted in FIG. 4(a). At 874 MPa, full amorphization was achieved, with no grain boundaries and pores observed in the surface SEM image FIG. 4(b). The MOF amorphization observed in the surface SEM image also agrees with the XRD data in FIG. 3.

FIG. 5 shows a glass transition temperature (Tg) of 59.69 °C in amorphous HKUST-1 MOF glass, which is characteristic of amorphous structure. In comparison, the HKUST-1 MOF powder does not have any glass transition temperature due to the crystalline structure.

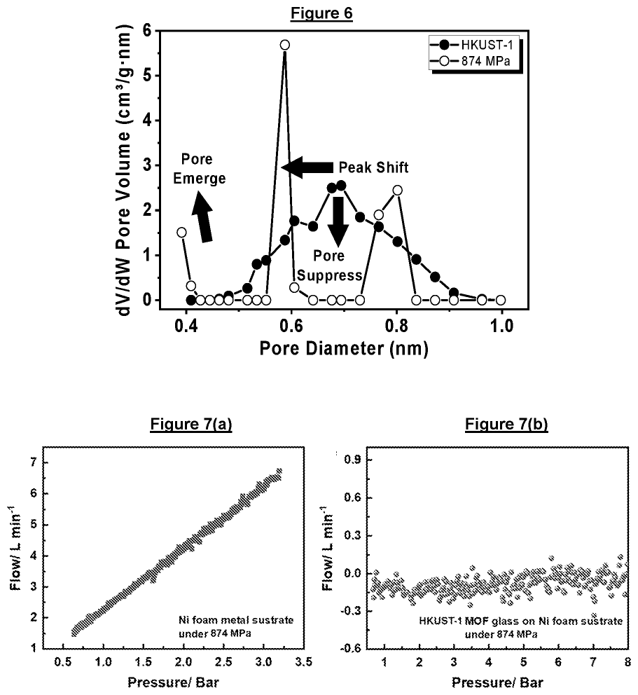

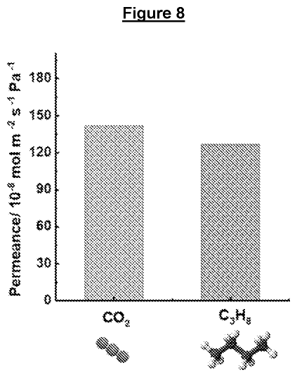

A Brunauer-Emmett-Teller (BET) study was conducted to determine the micropore sizes of the amorphous and crystalline HKUST-1 MOF. As shown in FIG. 6, the micropore size of crystalline HKUST-1 MOF undergoes three major changes after a pressure of 874 MPa was applied. Firstly, the large pore size distribution of 0.6-0.9 nm was suppressed due to the amorphization. Secondly, there is an obvious shift in the dominant pore peak from 0.7 nm to <0.6 nm. Lastly, there is an emerging pore peak at <0.4 nm, but the pore distribution below 0.4 nm is incomplete because pores smaller than the diameter of N₂ (testing gas, the N₂ molecule size: 0.36 nm) cannot be evaluated.

The decrease in micropore sizes was due to changes in the coordination linkers when the HKUST-1 MOF was subjected to the high pressure, forming a disordered amorphous structure. A smaller micropore size distribution would be helpful in improving the gas selectivity of the HKUST-1 MOF glass membrane. However, due to the use of uniaxial pressure (one direction—top down) in this case, only the surface of the MOF is amorphized, leading to residual pore peaks at 0.8 nm.

The porous Ni foam substrate showed much enhanced N₂ flow when the transmembrane pressure was increased from 0.64 bar to 3.20 bar, as shown in FIG. 7(a). In contrast, the HKUST-1 MOF glass film on Ni foam substrate showed ~0 N₂ flow from 0.64 bar to 8.00 bar (FIG. 7(b)). This proves that there were no macro-pores larger than 80 nm in the HKUST-1 MOF glass film.

As shown in FIG. 8, it can be seen that gas can pass through the glass-HKUST-1 MOF membrane, and that the glass-HKUST-1 MOF membrane has a penetrating channel for gas diffusion.

Whilst the foregoing description has described exemplary embodiments, it will be understood by those skilled in the technology concerned that many variations may be made without departing from the present invention.

1. An amorphous monolithic metal-organic framework membrane, wherein the membrane is free of grain boundaries and grain junctions.

2. The membrane according to claim 1, wherein the membrane is a continuous membrane.

3. The membrane according to claim 1, wherein the membrane comprises uniform pores.

4. (canceled)

5. The membrane according to claim 1, wherein the membrane has a gas flux of 10⁻⁴-10⁻⁶ m²s⁻¹Pa⁻¹.

6. The membrane according to claim 1, wherein the membrane is formed on a substrate.

7. The membrane according to claim 6, wherein the substrate comprises a metal foam.

8. The membrane according to claim 6, wherein the membrane is sandwiched between two substrates.

9. The membrane according to claim 8, wherein each of the two substrates may be the same or different substrate.

10. The membrane according to claim 1, wherein the membrane has a thickness of ≤10 μm.

11. The membrane according to claim 1, wherein the metal-organic framework comprised in the membrane comprises a copper-based metal-organic framework.

12. The membrane according to claim 1, wherein the metal-organic framework comprised in the membrane comprises an organic linker having a molecular weight of 150-250 g/mol.

13. The membrane according to claim 12, wherein the organic linker comprises: benzenetricarboxylate ligand, benzenedicarboxylate ligand, or a combination thereof.

14. A method of forming an amorphous monolithic metal-organic framework membrane, the method comprising:
providing metal-organic framework powder on a substrate; and
applying a pressure of ≤1 GPa to form the amorphous monolithic metal-organic framework membrane.

15. The method according to claim 14, wherein the substrate comprises a metal foam.

16. The method according to claim 14, wherein the metal-organic framework comprises a copper-containing metal-organic framework.

17. The method according to claim 14, wherein the metal-organic framework comprises an organic linker having a molecular weight of 150-250 g/mol.

18. The method according to claim 17, wherein the organic linker comprises:
benzenetricarboxylate ligand, benzenedicarboxylate ligand, or a combination thereof.

19. The method according to claim 14, wherein the applying comprises applying a pressure of 450 MPa to 1 GPa.

20. The method according to claim 14, wherein the applying is carried our at room temperature.

21. The method according to claim 14, wherein the method further comprises providing a further substrate thereby sandwiching the amorphous monolithic metal-organic framework membrane between the two substrates.
